(19) United States
(12) Patent Application Publication
(10) Pub. No.: US 2014/0083272 A1
(43) Pub. Date: Mar. 27, 2014

(54) PUNCH SYSTEM

(71) Applicant: Tavnir J. Carey, West Jordan, UT (US)

(72) Inventor: Tavnir J. Carey, West Jordan, UT (US)

(21) Appl. No.: 13/626,425

(22) Filed: Sep. 25, 2012

(51) Int. Cl. B26F 1/14

(52) U.S. Cl. 83/454

(57) ABSTRACT

A punch system includes a set of die plates having a first and second plate. The first and second plates are configured to align with each other. A series of die slots are arranged longitudinally along each die plate to create a pattern. The slots extend through the first and the second plates and have a shaped design. The punch system includes a punch having a punch plate with punch tip and a handle. The punch plate with punch tip is sized to extend through the first plate and partially into the second plate. The punch plate with punch tip is configured to match the shape of the configuration of the die slots in the die plates. The handle is disposed on an opposing end from the punch tip. The punch system also includes a receptacle disposed on the set of die plates. The receptacle is configured to store the punch when not in use.

### BACKGROUND OF THE INVENTION

1. The Field of the Invention

The present invention relates to a punch device and system that allows various ribbon patterns to be woven in a linear ornate pattern.

2. The Relevant Technology

Ribbons have been used in the past to decorate craft paper in scrapbooking and other projects. The typical method of attachment to the paper in the past has been to attach the ribbon with tape, glue or staples. This created the desired effect, except that often the residue of the attachment medium would be visible and detract from the desired appearance.

Hole punches may be utilized as a medium to secure a ribbon to craft paper, by threading the ribbon in and out of successively punched holes, but most punches in the past have been round (creating only round holes in the paper medium), and the punched holes have no intrinsic relationship one to the other, both in distance between holes and relative distance to the edge of the paper. Punching the holes in a uniform fashion with these past devices would be based on the ability of the user to judge relative distances, or by measuring and marking the location of the desired holes.

A later development, the Buckle Punch (US Patent Application 2008/0060567 A1), allowed for dual facing curved slots to be punched in paper with a punch device that looked like a buckle. After inserting the paper into a center slot in the buckle, one could press down on the buckle and punch four curved slots in the paper. The four holes form a circle made up of four quarter circle slots. The quarter slot is slightly less than a true quarter circle so that there is a small space not punched between each quarter circle slot, thereby allowing the integrity of the paper to be maintained between each slot. A ribbon could then be fed through the buckle holes, one at a time, forming a decorative circular pattern and allowing the buckle to be tied to the paper. The ribbon would then be tied over the buckle holding the buckle in place on the paper medium.

A disadvantage of this device is that if the user desired multiple buckles to be added, it would be necessary to be able to accurately judge, or measure the distances between the buckles prior to punching the new holes with the next buckle. Another disadvantage with the buckle device was that it had to be applied to the edge of the paper since the two halves of the buckle were joined on one side, not allowing the paper to slide all the way through the buckle. A third disadvantage with the buckle punch is that it can only be used one time, since it becomes a part of the decoration with the ribbon.

The paper punch invention allows the punched holes to be spaced anywhere on the paper and not only on the edge of the paper, and also provides automatic uniform spacing between the holes. Unlike the buckle punch, the paper punch may be removed to be used multiple times as a punch and does not become a part of the aesthetics with the ribbon. The ribbon remains woven in the slots that are punched.

There has been very limited ability to change the shape of the punched hole in the paper. The embodiment of this invention is to provide a multiplicity of designs in the punches, thereby providing many unique and aesthetically pleasing patterns as the ribbon passes through the holes in the paper in a woven pattern. With several slots lined up in a row, one can thread a ribbon in and out of the slots so that the ribbon is visible between every other slot.

### BRIEF SUMMARY OF THE PAPER PUNCH

A punch system includes a set of die plates having a first and second plate. The first and second plates are configured to align with each other. A series of die slots are arranged longitudinally along each die plate to create a pattern. The slots extend through the first and the second plates and have a shaped design.

The punch system includes a punch having a punch plate with punch tip and a handle. The punch plate is sized to extend through the first plate and partially into the second plate. The punch end is positioned through the first plate and at least partially into the second plate. The punch plate and punch end is configured to match the shape of the shape design of the slots. The handle is disposed on an opposing end from the punch tip.

The punch system also includes a receptacle disposed on the set of die plates. The receptacle is configured to store the punch when not in use.

In another aspect of the invention, a punch system includes a set of die plates having a first and second plate. The first and second plates are configured to align with each other. A series of die slots are arranged longitudinally along each die plate to create a pattern. The slots extend through the first and the second plates and have a shaped design. A set of magnets are disposed in the first and second plates to align the first plate with the second plate.

In a further aspect of the invention, a punch system includes a set of die plates having a first and second plate. The first and second plates are configured to align with each other. The set of die plates have an identification color. A series of die slots arranged longitudinally along each die plate to create a pattern. The slots extend through the first and the second plates and having a shaped design. The punch system includes a punch having a punch plate with punch tip and a handle. The punch plate is sized to extend through the first plate and partially into the second plate. The punch tip is positioned through the first plate and at least partially into the second plate. The punch plate with punch tip is configured to match the shape of the shape design of the slots. The handle is disposed on an opposing end from the punch tip. The punch handle is colored to match the identification color of the set of plates.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope. The invention will be described and explained with additional specificity and detail through the use of the accompanying drawing in which:

FIG. 1 is an isometric view of a punch system in accordance with the embodiments of the present invention.

FIG. 2 is an exploded view of the paper system of FIG. 1.

FIG. 3 illustrates a punch handle with one of several possible male punch designs in accordance with the present invention.

FIG. 4 shows the punch system being used to punch a medium in accordance with the present invention.

FIG. 5 illustrates a sectional view of the punch system showing a medium being punched in accordance with the present invention.

FIGS. 6A-C illustrate a ribbon being thread through a series of punched slots in a medium.

FIGS. 7A-F show various embodiments to punch slot configurations.

### DETAILED DESCRIPTION OF THE VARIOUS EMBODIMENTS

The embodiments of this invention include a paper punch. The paper punch provides a method for a user to be able to affix a ribbon in a preselected pattern onto craft paper or other medium (such as cloth, fiber paper, card stock or plastic). The paper punch allows the user to punch a pattern of holes in the craft paper or other medium in such a way that the punched slots can be spaced without measurement, because the measurement is provided in the patterned punch plates. Another advantage is that the pattern of slots may be placed on the edge of the paper, or placed anywhere on the body of the paper.

The paper punch is provided with die plates. The die plates have similar die slot patterns. Place the first die plate on a hard surface, place a piece of paper or other medium on top of the first die plate, positioning the medium in the desired place to be punched, then place the second die plate over the first die plate.

With proper alignment, it is possible to insert a male punch with punch tip through the female die slots in the each of the die plates. As the male punch passes through the two die plates, the paper or other medium that is sandwiched between the die plates may be punched in the same pattern as the male punch.

The die plates that are provided may be chosen from several patterns of matching die plates which may produce a number of selected patterns. The matching patterned die plates may be easy to select similar patterns, because they may be painted with different colors for each die pattern. You can select a desired set of die plates by matching the die slots in the die plates, and/or by selecting a matching color of die plates.

It is possible to align the die plates in several ways. One of these methods is as follows: The male punch is attached to a punch handle. The punch handle is provided with a resting station in the die plates. The resting station consists of a hole that extends through the die plates. If this hole is outside the paper or other medium, then this hole in these die plates may be used for alignment purposes. Alignment is provided by pushing the punch handle through the matching holes of the resting station.

Another method of alignment of the matching die plates is to press gently through the paper or other medium to determine if the first die plate is completely under the second die plate. If the first die plate is felt to be offset from the second die plate, then one can move the second die plate in relation to the first die plate, until they match.

After a preliminary alignment is achieved, by the methods described above, or other method, the final and most secure alignment is achieved by the discrete alignment of matching magnets that are positioned in the first and second die plates. The magnets are small enough that a definite alignment is achieved between the die plates.

These magnets are strategically placed in each die plate such that they align strategically one magnet on top of the other magnet. This stability allows the punched holes to maintain the desired positioning relative to each of the die plates and to the paper being punched. These magnets hold the die plates in place as slots are punched into the paper through the matching die slots in the upper and lower die plates.

This paper punch provides for a multiplicity of designs in the die plates, thereby providing many unique and aesthetically pleasing patterns to be punched in the paper or other medium. Subsequent to the punching of the paper, a ribbon may then be threaded through the punched slots in the paper in a woven pattern. The spacing and selection of the punched slot pattern may be preselected from various slot pattern designs available in the different styles of the die plates.

Once the slots have been punched in the paper or other medium, it may then be possible to insert a ribbon into the shots. The ribbon may be threaded in many patterns, only limited by the number of slots in the paper. The ribbon, when woven through each chosen slot, may form a distinct pattern at the choosing of the person performing the work. The ribbon may be laid flat between the slots, or it may be twisted between the slots as desired.

Once you have punched the desired pattern of slots in the paper, a ribbon may then be fed through each slot. After feeding the ribbon in and out of the slots in a somewhat longitudinal woven pattern, the visible ribbon may appear as a colored dotted line in the paper—half of the ribbon on one side of the paper and the other half on the other side. The ribbon may be woven through the slots in the paper in a way that the pattern on one side of the paper may be a minor image of the pattern on the other side of the paper. Another option would be to twist the ribbon between the slots in some desired number of twists.

Various embodiments of the present invention will now be discussed with reference to the appended drawings. It is appreciated that these drawings depict only typical embodiments of the invention and are therefore not to be considered limiting of its scope.

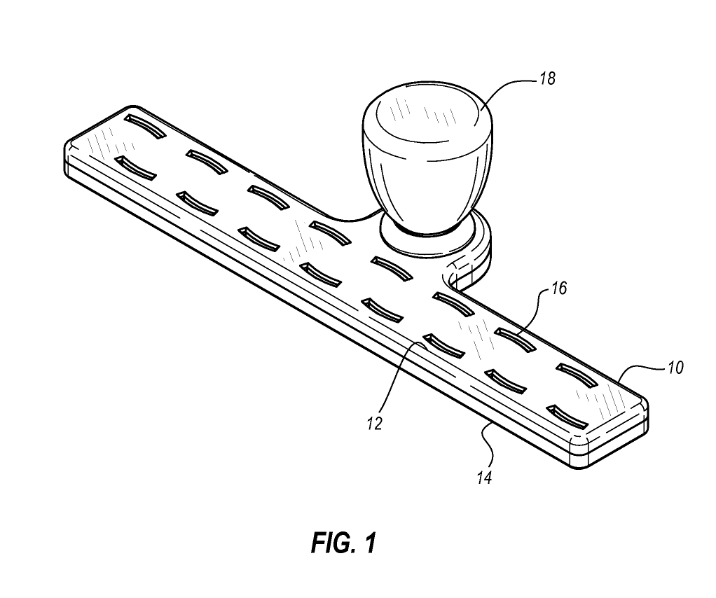

FIG. 1 illustrates an embodiment of the paper punch invention in a three dimensional view 10. The paper punch includes a set of die plates, for example, a first die plate 12 and a second die plate 14. Each of the die plates, for example, the first 12 and second 14, have die slots 16 that extend through the entire depth of both the first and second plates. The first and second plates are configured to align with each other.

The die slots 16 in both the first die plate 12 and the second die plate 14 match each other so that when one die plate is placed on top of the other die plate, a common matching slot is formed between the two die plates. A series of die slots are arranged longitudinally along each die plate to create a pattern.

The slots extend through the first and the second plates and have a shaped design. Examples of particular shapes are discussed below. The outer edges of the first and second die plates may be formed so that when one is placed on top of the other, they may appear as a single unit with common sides. The set of die plates may include an alignment edge along one side of the plates. The alignment edge is configured to align the set of die plates along the medium to be punched. Accordingly, a user may align the die plates 12 and 14 to use the punch.

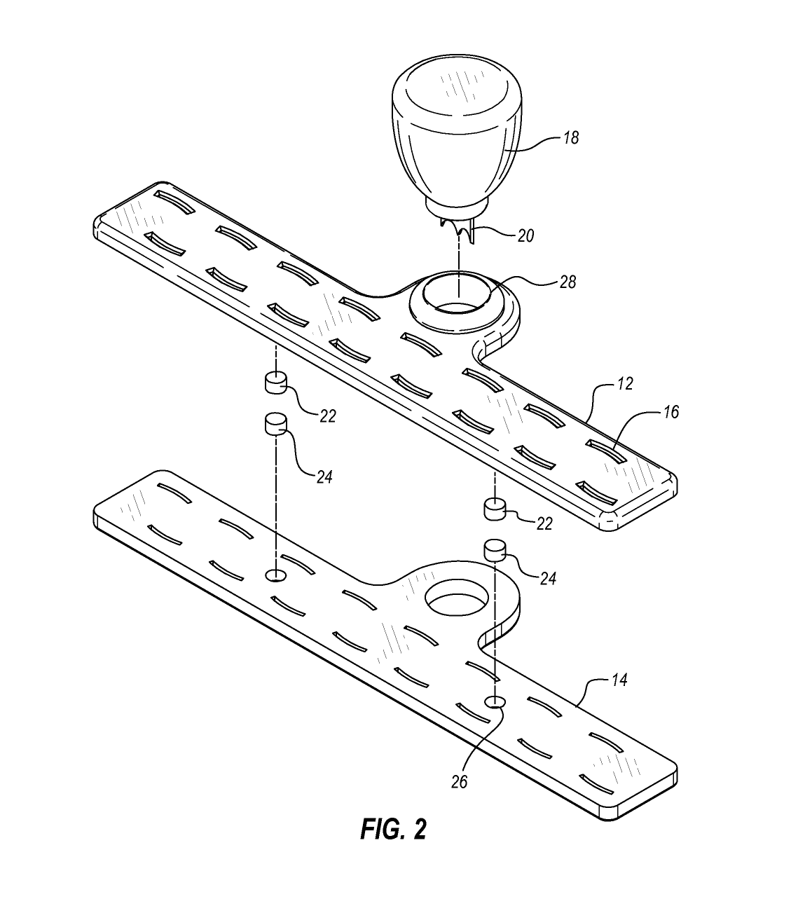

FIG. 2 displays the exploded three dimensional view of a paper punch. The first and second die plates 12 and 14 are shown here in the separated position which is where they would be to enable the craft paper or other medium to be placed between them. The die slots 16 in both the first die plate 12 and the second die plate 14 are fabricated such that they match each other. The outer edges of the first 12 and second 14 die plates are similarly machined to match each other so that it may be seen if the alignment of the two die plates has occurred and that they are in alignment and positioned for use.

A punch consisting of a handle, a punch plate with punch tip may be included with the system. The punch plate with punch tip is sized to extend through the first plate and partially into the second plate. The punch plate and punch tip are configured to match the shape of the configuration of the slots in the die plates. The handle is disposed on an opposing end from the punch tip.

In both the first and second die plate there is provided a receptacle or resting station 28 for the punch handle 18. This resting station 28 provides a convenient location to store the punch handle 18 with male punch 20 attached. The resting station is disposed on the set of die plates and is configured to store the punch when not in use. The resting station is configured to align the first plate with the second plate when the punch is placed in the receptacle.

The punch handle 18 is provided with several male punches, but only one male punch may be used with a matching die slot in the die plates. If a different pattern slot is desired, then one may select a different male punch and a set of matching female die plates. To enable one to select the matching combinations of die plates and male punches, they may be color coated to assist in that selection.

Various embodiments die slots may be used with the paper punch 10. One of the features of this invention is the ability to hold the first and second die plates 12, 14 together. One embodiment provides matching magnet locating holes 26 on the interior of the first and second die plate with magnets strong enough to hold the plates together through a medium. These locating holes can be placed in opposing locations of the first die plate 12 and the second die plate 14 as shown so that the first magnets 22, when inserted and fastened in place in the locating holes, can be positioned across from the second magnets 24. The magnetic force between the two magnets can then snap the pieces together in alignment. Thus the first and second die plates 12 and 14, can be held tightly together when placed uniformly on top of one another. A set of magnets may be disposed in the first and second plates to align the first plate with the second plate. The set of magnets are sized to provide a precision alignment of the first plate to the second plate and align the die slots of one plate with another. The precision alignment means that the magnets are small enough to provide a small tolerance of alignment. The magnets are strong enough to snap the plates together when the magnet of one plate connects with a magnet of the adjoining plate.

The first and second die plate can be provided with a resting station 28 or receiving hole for the punch handle 18. This resting station 28 allows a convenient location to store the punch handle 18. The receiving hole for the punch handle 18 in the first die plate 12 and the second die plate 14 can be formed such that the plates can match uniformly with each other when they are in proper alignment. The punch handle 18 can also be fabricated such that it forms a snug fit, matching the resting station hole. It may therefore be possible to align the first die plate 12 and the second die plate 14 to each other by pressing the punch handle 18 into the resting station hole 28.

The die plates may include an alignment edge to align the plates together. When the alignment edge of one plate is flush with an alignment edge of another plate, the series of die slots are also aligned.

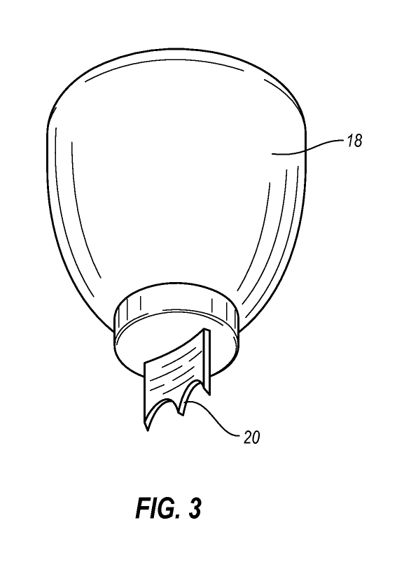

FIG. 3 is a detail view of a punch handle 18 with the male punch 20 including the punch tip. The punch tip is the tip end of the punch plate which is inserted at the base of the punch handle. This punch handle is designed to be gripped by a user's hand and can be sized to allow a typical user to grasp it and push it multiple times through the die plate slots 16 in a repetitious manner. At the base of the punch handle 18 is the male punch 20. The male punch may be provided in multiple shapes, but can match the die slot 16 pattern for a particular set of die plates.

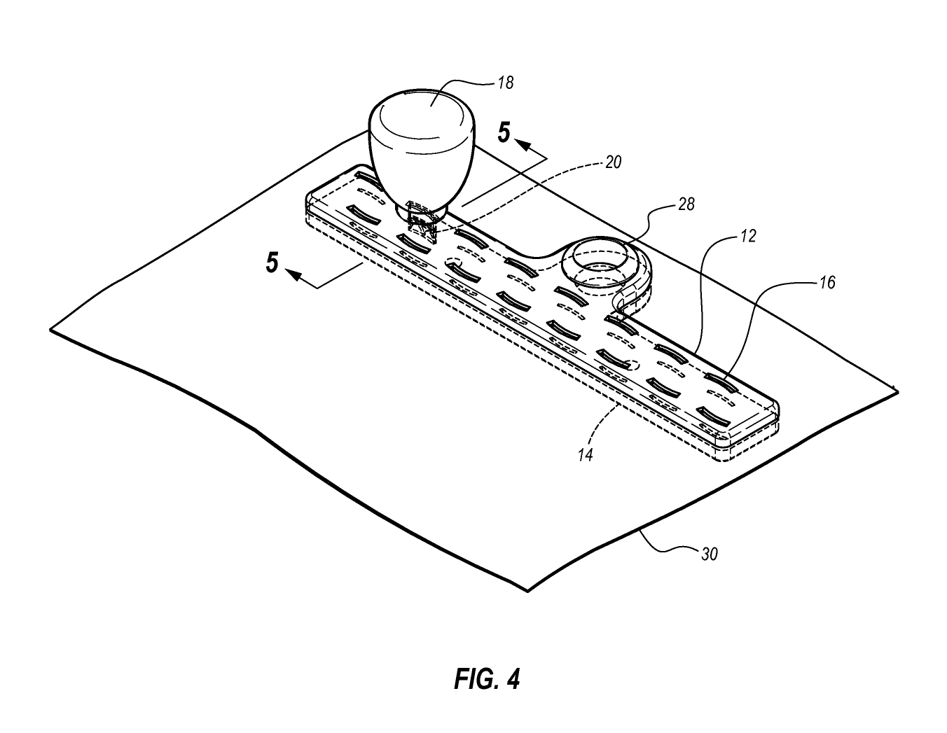

FIG. 4 depicts a three dimensional view of the paper punch 10 in operation. In this view, the paper punch is shown with a piece of craft paper, or other medium 30 held rigidly in place by being sandwiched between the two halves of the first and second die plates 12 and 14. The punch handle 18 with the male punch 20 is removed from the resting station 28 and placed over the die slots 16 so that it is in a position to be pushed through this die slot 16 located in the upper and lower punch plate 12 and 14. The shape of this male punch must match and be slightly smaller than the paper punch die slots 16 in the die plates 12 and 14. The two halves of the die plates 12 and 14 may be held tightly in place by means of the adjacent magnets embedded in the first and second die plate. In addition to holding the die plates together, the craft paper or other medium 30 that is sandwiched between the die plates may also be held tightly by the pressure of this magnetic force. The exterior dimensions of the first and second die plates 12 and 14 match each other so that the person utilizing the paper punch may be able to observe that the upper die plate 12 is directly over the lower die plate 14. By exerting pressure on the craft paper at the point where the paper enters the confines of the matching die plates, a user can determine if there is an overhang of one die plate in relation to the other, indicating the two halves of the die plates are mismatch. A slight shift of the first die plate in relation to the second may then eliminate that overhang, or mismatch between the two die plates. The other method to consider proper alignment is to test the relative strength of the attraction between magnets 22 and 24 holding the two halves together. Another test of alignment can be implemented by pushing the male punch through the various die slots 16. If the male punch is difficult to push through the entire thickness of the first and second die plates, then there is an alignment problem due to shifting of the first or second die plate. The user can realign the plates until the upper and lower plates match.

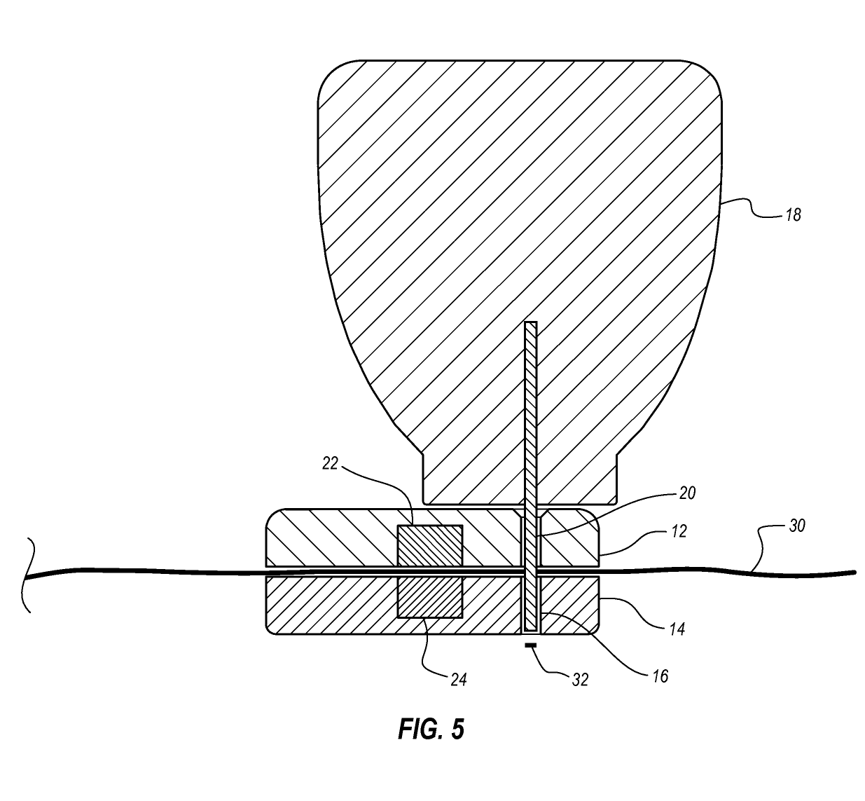

FIG. 5 is a cross section of the paper punch 10 showing the punch handle 18 and male punch 20 in the process of punching through the first die plate 12, the paper medium 30, and the second die plate 14. The die slots 16 in the first die plate 12 and second die plate 14 are guides for the male punch 20. The leading edge of the die slot in the second die plate can be used as a shear cutting edge where the shearing of the paper medium takes place as the male punch 20 moves through the first and second die slots 16. The male punch 20 must match the shape of the die slots 16, and may be slightly smaller. Easy passage of the male punch 20 through the die slots 16 is tempered by the cutting, or shearing action applied to the paper that is sandwiched between the die plates and can be achieved by a tighter or more restrictive passage of the male punch as it passes through the female die slots 16. Due to the tight clearance between the male punch 20, and the punch slot 16, as well as the upper and lower punch plates being held rigidly in place with the first and second magnets 22 and 24, the craft paper 30 may have a slot punched cleanly through the paper. The result of this punching action is that the slot is cut into the paper medium and the paper scarf 32 drops through the die slot 16 in the lower die 14.

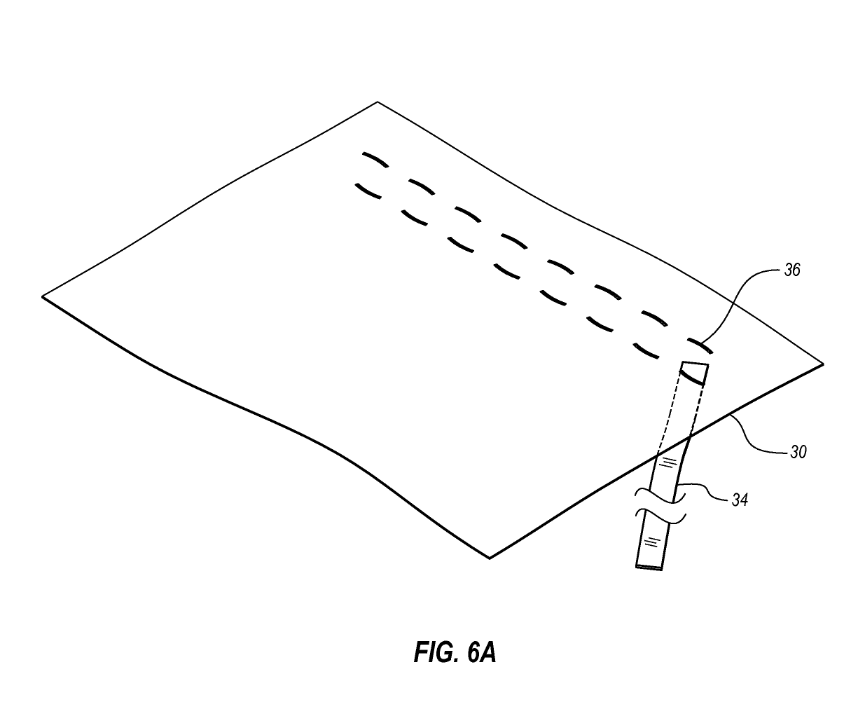

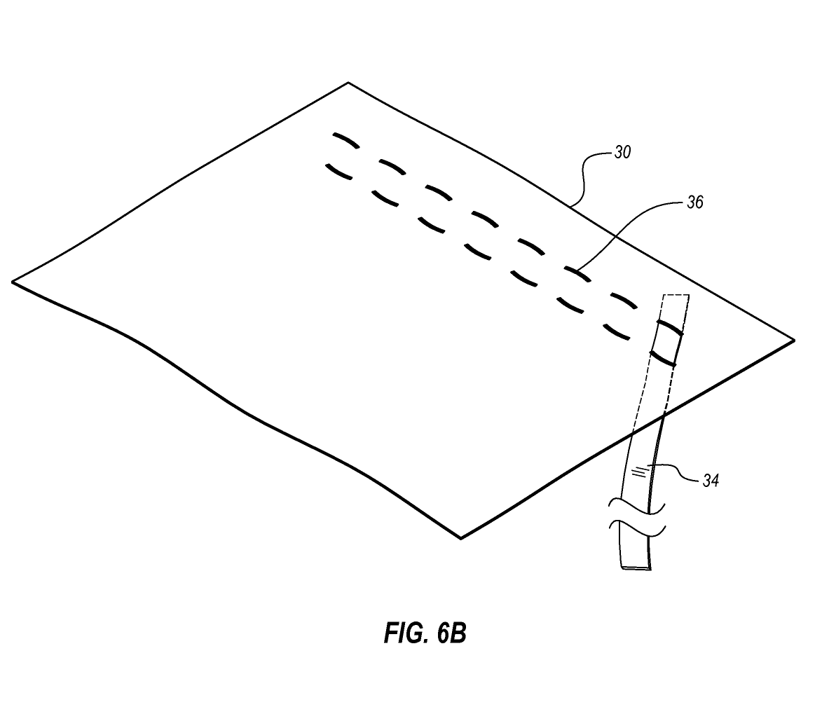

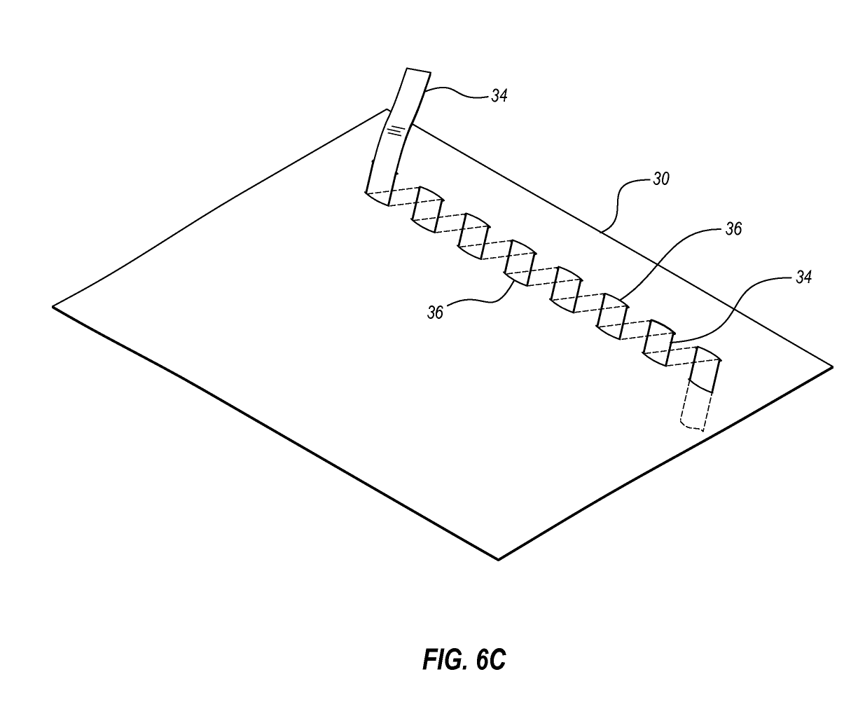

FIG. 6A shows the ribbon 34 to be inserted into the paper slot 36 that is one of a series of slots in a pattern in the craft paper or other medium 30.

FIG. 6B displays the ribbon 34 as it exits the first paper slot 36 in the craft paper or other medium 30. The ribbon may remain in the orientation as shown as it is being pushed through the paper slot and as it proceeds to the next slot, or it may be twisted any number of times as it is taken to the next slot. In the next slot, the ribbon may be inserted in an opposite direction as the previous slot.

FIG. 6C illustrates the completed ribbon assembly after weaving the ribbon 34 through all the paper punch slots 36. This figure shows the ribbon woven in a flat pattern. As mentioned, the ribbon may also be twisted in between slots, thereby creating a different effect.

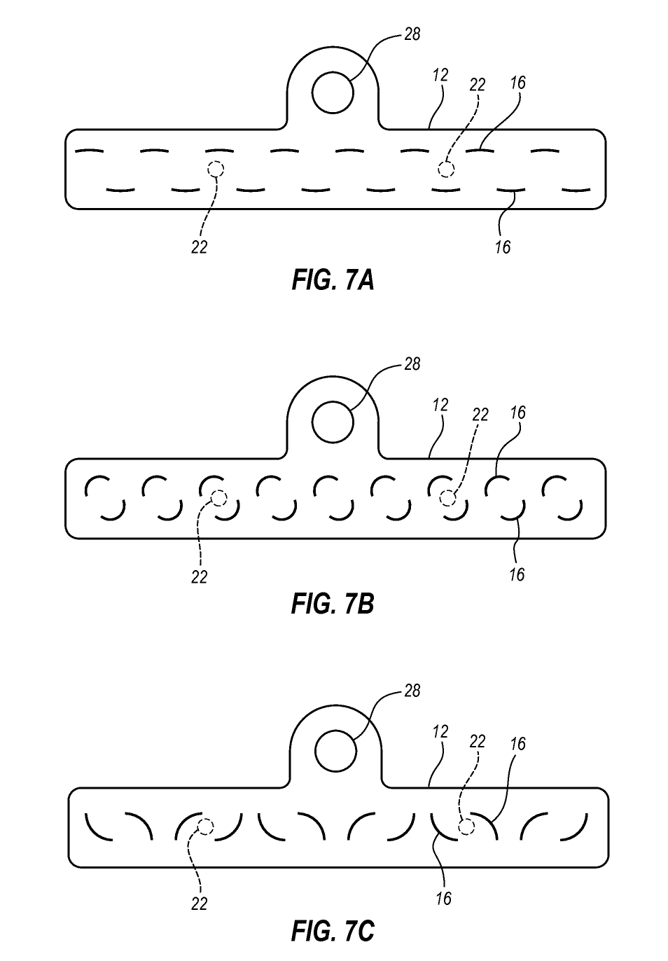

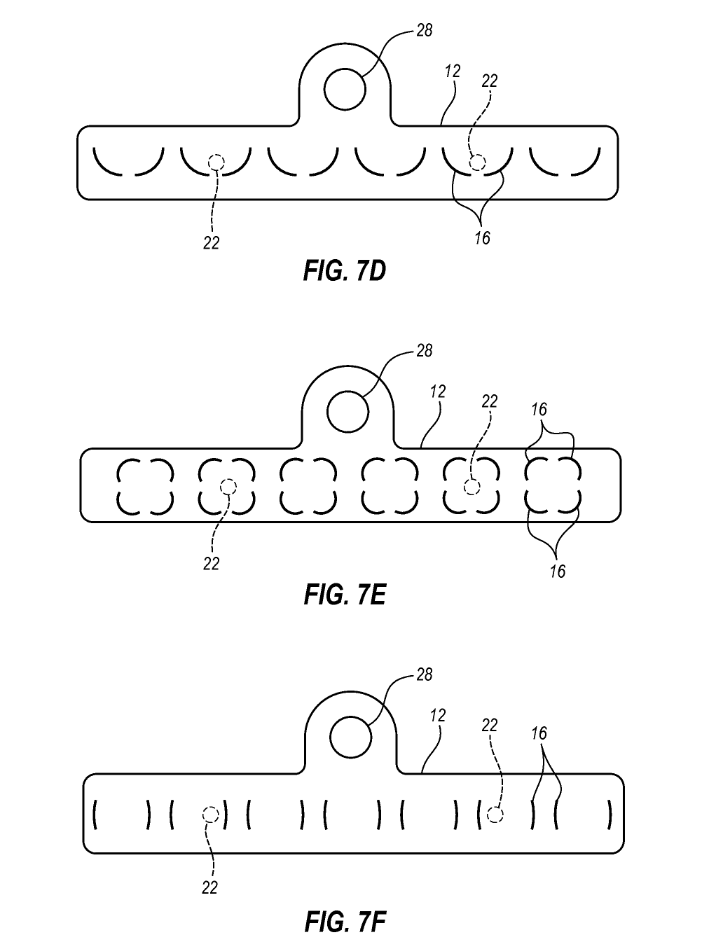

FIG. 7A through 7F depict various arrangements of the die slot 16 designs that may be placed in the first and second die plates 12 and 14. For the sake of brevity, only the first die plate 12 is shown in each case. This is not to construe that these designs are the only possible configurations, but only several options that are possible. With each of these options, a unique ribbon pattern is possible with a ribbon being woven through the slots. The patterns may include a series of slots alternating between slots in a first position and in a second position. The second position may have a design shape that is rotated about 180 degrees from the first position along the pattern.

The pattern may further include a third position having a design shape that is rotated about 90 degrees from the first position along the pattern. The pattern may also have a fourth position with a design shape that is rotated about 180 degrees from the third position along the pattern. FIG. 7A is a series of opposing slightly curved die slots in a double linear pattern. The slots are oriented such that one slot is placed at 90 degrees and the other is placed at 180 degrees. These die slots are placed in the first die plate 12 and second die plate 14.

A set of die plates may have a first plate configured to align with another plate. The set of die plates may be encoded with an identification color to indicate which pieces match. The punch is configured to match the shape of the shape design in the slots. The punch may be encoded similar to the color of the plates. The color of the punch may then match the identification color of the set of plates. The identification color of the plates may be provided for a specific shaped design. Some examples of the possible slot shapes and design configurations are discussed below.

FIG. 7B shows an optional design with curved die slots 16 in a series of die slots in a double linear pattern. The slots are oriented such that one slot is placed at about 315 degrees and the other is placed at about 135 degrees, or rotated about 180 degrees from each other. These die slots may be placed in the first die plate 12 and second die plate.

FIG. 7C shows the slots with opposing moderately curved die slots 16 in a single linear pattern. The slots are oriented such that one slot is placed at about 315 degrees and the other is placed at about 135 degrees, or rotated about 180 degrees from each other. These die slots are placed in the first die plate 12 and second die plate.

FIG. 7D shows an option of die slots 16 that create two halves of a half circle, or in other words two half circles, a mirror image of one another. The slots are oriented such that one slot is placed at 315 degrees and the other is placed at 225 degrees, or rotated about 90 degrees from each other. These die slots are placed in the first die plate 12 and second die plate.

FIG. 7E shows an option with a square pattern die slot 16 design. The corners of the square are the curved corners that form the die slots, thereby displaying a double linear pattern of pairs of die slots. The slots are oriented such that one slot is placed at about 45 degrees, another is at about 135 degrees, a third at about 225 degrees and the fourth is placed at about 315 degrees. In other terms, these slots are rotated about 90 degrees from each other. These die slots are placed in the first die plate 12 and second die plate.

FIG. 7F shows a pattern with opposing vertical slightly curved die slots 15 in the die plate 12. The slots are oriented such that one slot is placed at about 90 degrees and the next is at about 180 degrees. These die slots are placed in the first die plate 12 and second die plate.

The punch system provides a method to punch a pattern of uniformly spaced slots in a piece of craft paper or similar medium, thereby allowing a ribbon to be threaded through those slots in a woven pattern. This is accomplished by placing the craft paper or other medium between an upper and lower die plate. The upper and lower die plates are manufactured in such a way that they have matching slots machined in them so that when placed back to back, the slots line up with each other. With the slots lining up on the upper and lower die plates and the craft paper held firmly between the die plates, a punch may be manually utilized to push through the matching slots in the die plates and with that action, punch a slot into the craft paper that is sandwiched between the die plates. Since the slots in the upper and lower die plates have a regular pattern that has been preselected it is possible to continue manually punching the slots in the craft paper, one at a time, until the desired number of slots have been punched.

The upper and lower die plates can be held firmly together thereby maintaining the alignment of the two die plates as well as holding the paper in place and not allowing relative slippage between these interfaces. The punch system may have machined matching interior cutouts in both the upper and lower die plates where opposing pairs of magnets are provided. The attraction between the magnets provides the force necessary to hold the upper and lower die plate together as well as sandwich the craft paper between them, holding the paper securely between the plates. This allows the slots in the upper and lower die plates to maintain relative alignment to each other as well as accuracy in the slots being punched in the craft paper.

This invention provides for a multiplicity of slot designs in the die plates, thereby providing many unique and aesthetically pleasing patterns. The ribbon may therefore be woven in and out of the slots in a decorative fashion as allowed by any of these several optional die plate patterns.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A punch system comprising:
a set of die plates including a first and second plate, the first and second plates being configured to align with each other;
a series of die slots arranged longitudinally along each die plate to create a pattern, the slots extending through the first and the second plates and having a shaped design;
a punch having a punch plate, a punch end and a handle, the punch plate being sized to extend through the first plate and partially into the second plate, the punch end being positioned through the first plate and at least partially into the second plate, the punch plate and punch end being configured to match the shape of the shape design of the slots, the handle disposed on an opposing end from the punch end; and
a receptacle disposed on the set of die plates, the receptacle being configured to store the punch when not in use.

2. The punch system of claim 1, wherein the receptacle is configured to align the first plate with the second plate when the punch is placed in the receptacle.

3. The punch system of claim 1, wherein the pattern includes a series of slots alternating between slots in a first position and in a second position, the second position having a design shape that is rotated about 180 degrees from the first position along the pattern.

4. The punch system of claim 3, wherein the pattern further includes a third position having a design shape that is rotated about 90 degrees from the first position along the pattern.

5. The punch system of claim 4, wherein the pattern further includes a fourth position having a design shape that is rotated about 180 degrees from the third position along the pattern.

6. The punch system of claim 1, wherein the set of die plates includes an alignment edge along one side of the plates, the alignment edge being configured to align the set of die plates along the medium to be punched.

7. A punch system comprising:
a set of die plates including a first and second plate, the first and second plates being configured to align with each other;
a series of die slots arranged longitudinally along each die plate to create a pattern, the slots extending through the first and the second plates and having a shaped design; and
a set of magnets disposed in the first and second plates to align the first plate with the second plate.

8. The punch system of claim 7, wherein the set of magnets are sized to provide a precision alignment of the first plate to the second plate and align the die slots of one plate with another.

9. The punch system of claim 7, wherein each die plate includes an alignment edge to align, when the alignment edge of one plate is flush with an alignment edge of another plate, the series of die slots are also aligned.

10. A punch system comprising:
a set of die plates including a first and second plate, the first and second plates being configured to align with each other, the set of die plates having an identification color;
a series of die slots arranged longitudinally along each die plate to create a pattern, the slots extending through the first and the second plates and having a shaped design; and
a punch having a punch plate with a punch tip, and a handle, the punch plate with punch tip being sized to extend through the first die plate and partially into the second die plate, the punch plate and punch tip being configured to match the shape of the configuration of the die slots, the handle disposed on an opposing end from the punch tip, the punch being colored to match the identification color of the set of plates.

11. The punch system of claim 10, wherein the identification color of the plates is provided for a specific shaped design.
